(19) United States
(12) Patent Application Publication
(10) Pub. No.: US 2024/0119843 A1
(43) Pub. Date: Apr. 11, 2024

(54) SHIP NAVIGATION DISPLAY SYSTEM AND SHIP NAVIGATION DISPLAY METHOD

(71) Applicant: INSTITUTE FOR INFORMATION INDUSTRY, Taipei (TW)

(72) Inventors: Jia Hao Wang, Taipei (TW); Zhi Ying Chen, Taipei (TW); Hsun Hui Huang, Taiei (TW); Chien Der Lin, Taipei (TW)

(21) Appl. No.: 17/985,172

(22) Filed: Nov. 11, 2022

(30) Foreign Application Priority Data
Oct. 7, 2022 (TW) 111138155

(51) Int. Cl. G08G 3/02; B63B 49/00; G06F 3/01; G06T 19/00

(52) U.S. Cl. CPC G08G 3/02; B63B 49/00; G06F 3/017; G06T 19/006; G06F 1/163

(57) ABSTRACT

A ship navigation display system is set in a ship and includes a communications device, sensing device, first computing device, second computing device and wearable device. The communications device receives first coordinate information corresponding to a ship. The sensing device senses second coordinate information corresponding to a first ship around the ship. The first computing device is communicably connected with the communications device and calculates a collision probability according to the first and second coordinate information. When the collision probability is greater than a threshold value, the first computing device transmits a collision prediction signal. The second computing device receives the collision prediction signal and projects the second coordinate information corresponding to the first ship to a virtual coordinate in a virtual space. The wearable device receives the virtual coordinate and displays an augmented reality image including a virtual object and the first ship located in a physical environment.

### FIELD OF THE INVENTION

The present invention relates to a ship navigation display system and a related ship navigation display method.

### BACKGROUND OF THE INVENTION

At present, possible collision in ship advancement is primarily sensed by electronic devices, and assistant information is presented to a driver in a cabin. However, the assistive information most of the time is not presented in real-time and may not be intuitive enough. Consequently, even though reference can be made to the assistive information, the driver in the cabin still requires a personnel outside the cab to occasionally observe surrounding conditions of the ship by way of naked eyes and reports the surrounding conditions back to the driver as a reference of operating and driving, so as to effectively avoid collision of a ship during advancement.

For example, when the ship navigates in different sea areas (e.g., harbor areas, coasts or open seas), although the driver in the cabin may sense surrounding objects by utilizing the electronic device, the content displayed by an instrument cannot directly respond to a picture actually seen by the naked eyes, such that related information of the objects seen by the naked eyes cannot be associated and presented in real time. In addition, the assistant information provided by the instrument is not directly synchronized to the personnel outside the cab for assisting inspection. Above-mentioned lagging of information may leave the driver in the cabin insufficient response time to avoid collision.

In view of the above, how to provide real-time ship information integration and collision prediction analysis and present the information intuitively to crews or the driver is an important issue to the navigation safety.

### SUMMARY OF THE INVENTION

One of the objectives of the present invention is to provide a real-time collision sensing ship navigation display system and a related navigation display method in an intuitive and user-friendly manner, so as to solve the above-mentioned problems.

In order to achieve the above-mentioned objective, the present invention provides a ship navigation display system set in a ship in a physical environment. The ship navigation display system includes a communications device, a sensing device, a first computing device, a second computing device and a wearable device. The communications device is configured to receive first coordinate information corresponding to the ship; the sensing device is communicably connected with the communications device, and is configured to sense second coordinate information corresponding to a first ship around the ship; the first computing device is communicably connected with the communications device, and is configured to calculate a collision probability according to the first coordinate information and the second coordinate information, wherein when the collision probability is greater than a threshold value, the first computing device transmits a collision prediction signal; the second computing is communicably connected with the first computing unit, and is configured to receive the collision prediction signal and to project the second coordinate information corresponding to the first ship to a virtual coordinate in a virtual space; and the wearable device is communicably connected with the second computing unit, and is configured to receive the virtual coordinate and to display an augmented reality image, wherein a content of the augmented reality image comprises a first virtual object corresponding to the virtual coordinate and the first ship located in the physical environment.

The present invention further discloses a ship navigation display method applied to a ship navigation display system in a ship in a physical environment. The ship navigation display system includes a communications device, a sensing device, a first computing device, a second computing device and a wearable device, wherein the sensing device is communicably connected with the communications device, the first computing device communicably connected with the communications device, the second computing device is communicably connected with the first computing device, and the wearable device is communicably connected with the second computing device. The ship navigation display method includes: receiving, by the communications device, first coordinate information corresponding to the ship; sensing, by the sensing device, second coordinate information corresponding to a first ship around the ship; calculating, by the first computing device, a collision probability according to the first coordinate information and the second coordinate information, wherein when the collision probability is greater than a threshold value, the first computing device transmits a collision prediction signal; receiving, by the second computing, the collision prediction signal and projects the second coordinate information corresponding to the first ship to a virtual coordinate in a virtual space; and receiving, by the wearable device, the virtual coordinate and displaying, by the wearable device, an augmented reality image, wherein a content of the augmented reality image comprises a first virtual object corresponding to the virtual coordinate and the first ship located in the physical environment.

The present invention further discloses a ship navigation display method applied to a first computing device. The first computing device is communicably connected with a second computing device, a communications device and a sensing device respectively. The ship navigation display method includes: receiving first coordinate information corresponding to a ship from the communications device; receiving second coordinate information corresponding to a first ship from the sensing device; and calculating a collision probability according to the first coordinate information and the second coordinate information, wherein when the collision probability is greater than a threshold value, a collision prediction signal is transmitted to the second computing device which receives the collision prediction signal and projects the second coordinate information corresponding to the first ship to a virtual coordinate in a virtual space; and displaying, by a wearable device, an augmented reality image, a content of the augmented reality image including a first virtual object corresponding to the virtual coordinate and the first ship located in the physical environment.

The present invention further discloses a ship navigation display system. The ship navigation display system is communicably connected with a wearable device and is set in a ship in a physical environment. The ship navigation display system includes a communications device, a first computing device and a second computing device. The communications device is configured to receive first coordinate information corresponding to the ship; a sensing device communicably connected with the communications device is configured to sense second coordinate information corresponding to a first ship around the ship. The first computing device communicably connected with the communications device is configured to calculate a collision probability according to the first coordinate information and the second coordinate information, wherein when the collision probability is greater than a threshold value, the first computing device transmits a collision prediction signal. The second computing device communicably connected with the first computing device is configured to receive the collision prediction signal, to project the second coordinate information corresponding to the first ship to a virtual coordinate in a virtual space and to transmit an augmented reality image to the wearable device to display, a content of the augmented reality image comprising a first virtual object corresponding to the virtual coordinate and the first ship located in the physical environment.

In view of the above, the present invention relates to a ship navigation assistant system applying a mixed reality. The system gathers ship-related information from multiple electronic devices by means of the communications device, the sensing device and a dedicated communications protocol for ships, then performs collision prediction analysis by integrating the above-mentioned ship information and downloaded sea area classification information by means of the first computing device to generate collision caution information, and imports the above-mentioned ship information and the collision caution information into an augmented reality device (or a mixed reality device), so that the wearable device presents the ship navigation information and provides man-machine interaction.

### BRIEF DESCRIPTION OF THE DRAWINGS

The above-mentioned technical solution as well as other technical solutions will be described in more details now with reference to the drawings. These drawings shall not be regarded to be limitative. On the contrary, the drawings are used for helping description and understanding.

FIG. 1 is a schematic diagram of a ship navigation display system according to an embodiment of the present invention.

FIG. 2 is a schematic diagram of a physical environment.

FIG. 3 is a schematic diagram of a wearable device of the ship navigation display system displaying an augmented reality image.

FIG. 4A is a flowchart of a ship navigation display method for collision prediction according to an embodiment of the present invention.

FIG. 4B is a flowchart of a micro computing processing box for collision prediction according to an embodiment of the present invention.

### DETAILED DESCRIPTION OF PREFERRED EMBODIMENTS

The present invention is particularly described in the examples below, and these examples are merely used for illustration. Those skilled in art can still make various alterations and modifications without departing from the scope and spirit of the present invention. Therefore, the protection scope of the present invention shall be subject to the protection scope defined by the claims attached below. In the entire description and claims, unless otherwise specified, meaning of “one” and “the” includes a type of narration including “one or at least one” of the assemblies or components. In addition, as used herein, unless it is apparent to exclude plural forms from specific context, singular articles also include narration of a plurality of assemblies or components. Unless otherwise noted, terms used in the entire description and claims usually have common meaning in the field, the disclosed content and the specific content. Some terms for describing the present invention will be discussed below or elsewhere in the description to provide practitioners with extra guidance on description about the present invention. Examples throughout the entire description, including examples of any term discussed herein, are merely used for illustration and not meant to limit the scope and meaning of the present invention or any exemplary term. Similarly, the present invention is not limited to various embodiments provided in the description.

In addition, a term “electric (electrical) coupling” or “electric (electrical) connection” or “communications connection” used herein includes either any direct or indirect electrical connection mean or wireless or wired connection means. For example, when a first device is electrically coupled to a second device herein, it represents that the first device can be directly connected to the second device or is indirectly connected to the second device by means of other devices or connection means.

It is to be understood that terms “comprising”, “including”, “having”, “containing”, “involving” and the like used herein are open-ended, which refers to including, but not limited to. In addition, any embodiment or claim of the present invention has not to achieve all objectives or advantages or features of the present invention. Furthermore, the abstract and title are merely used for searching for patent documents in an assisted manner and are not intended to limit the scope of the patent claim of the present invention.

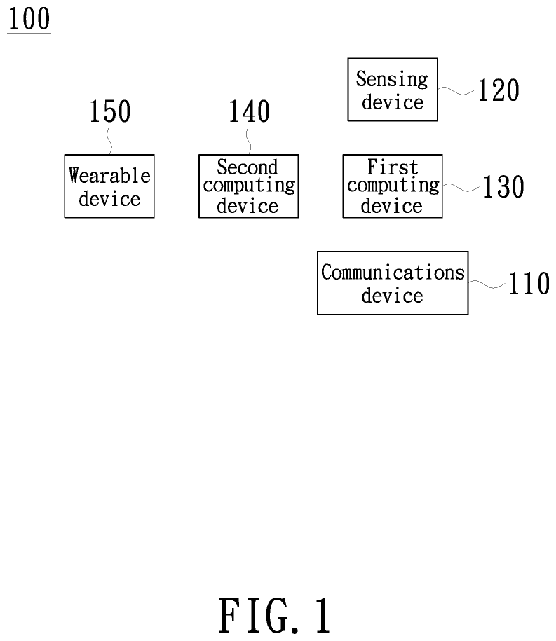

Referring to FIG. 1, FIG. 1 is a schematic diagram of a ship navigation display system 100 according to an embodiment of the present invention. As shown in FIG. 1, the ship navigation display system 100 includes a communications device 110, a sensing device 120, a first computing device 130, a second computing device 140 and a wearable device 150. The communications device 110 is configured to at least receive first coordinate information corresponding to a ship BO, and the communications device 110 may include a global positioning system (GPS), so as to receive longitude and latitude data.

As shown in FIG. 1 that illustrates the architecture diagram of the ship navigation display system 100, the first computing device 130 can be achieved by a micro computing processing box, the second computing device 140 can be achieved by a mobile phone, and the wearable device 150 can be achieved by a pair of AR (Augmented Reality) eyeglasses. The first computing device 130 includes an automatic identification system (AIS) ship information receiving module to receive AIS ship information (e.g., numbers and names of ships around) and navigation information (e.g., navigation direction and velocity), a longitude and latitude receiving module to receive a GPS longitude and latitude position of the ship itself, and a radar information receiving module to receive sensing results (such as sizes of the ships around and distances to the ships around) of the nearby ships. After collecting the above-mentioned information, the first computing device 130 will run preprocessing programs and perform ship information screening calculation and collision prediction by taking longitude and latitude as an index after integration, wherein a screening grade interval can be selected according to the position of ship navigation (which could be known via sea area classification information). For example, different screening grade intervals are selected according to ship navigation in a short sea or an open sea. By properly selecting the screening grade intervals, the processing efficiency can be shortened. The first computing device 130 is linked to the wearable device 150 by means of the second computing device 140, such that the wearable device 150 presents an augmented reality image. In addition, the first computing device 130 can also be linked to the wearable device 150, such that the wearable device 150 may present the augmented reality image.

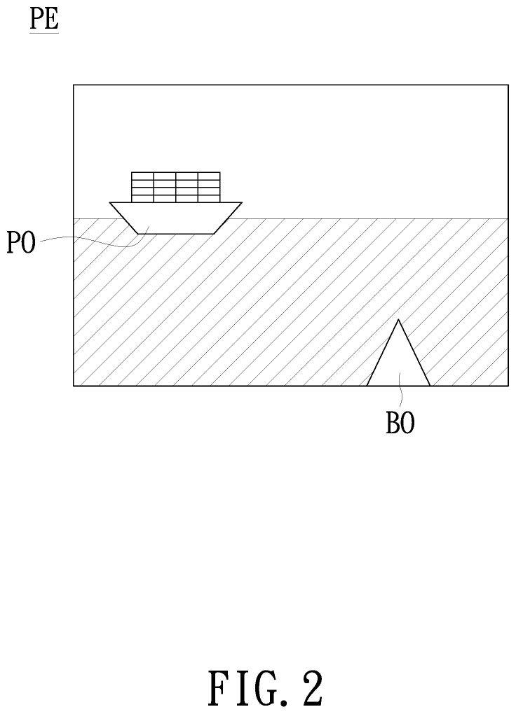

Next, referring to FIG. 1 and FIG. 2 altogether, FIG. 2 is a schematic diagram of a physical environment PE, wherein the ship navigation display system 100 can be set on the ship BO in the physical environment PE, and FIG. 2 corresponds to a visual field of a user (e.g., personnel in a cabin) and only displays a front end part of the entire ship BO. The sensing device 120 is communicably connected with the communications device 110 and is configured to sense second coordinate information corresponding to a first ship PO around the ship BO. Specifically, the first coordinate information may include a coordinate of the position of the ship BO, for example, the coordinate of the head, tail or middle of a ship. Similarly, the second coordinate information may include a coordinate of the position of the first ship PO.

From above, the sensing device 120 may include radar and the AIS to respectively receive radar data and AIS information of the corresponding ships. According to an embodiment of the present invention, the sensing device 120 is further configured to sense a ship number, a ship name, a ship size, a ship distance, a navigation direction and a velocity corresponding to the first ship. The first computing device 130 is communicably connected with the communications device 110 and is configured to calculate a collision probability between the ship BO and the first ship PO according to the first coordinate information and the second coordinate information. By way of illustration rather than limitation, when the collision probability is calculated, the first computing device 130 can calculate the collision probability according to the first coordinate information, the second coordinate information, the ship size (including the ship sizes of the ship BO and the first ship PO), the ship distance (e.g., the distance between the ship BO and the first ship PO), the navigation direction and the velocity.

The collision probability of the ship can be calculated by means of an improved sweep line (SL) algorithm, but the present invention is not limited thereto. When the collision probability is greater than a threshold value, the first computing device 130 will transmit a collision prediction signal, and the second computing device 140 or the wearable device 150 will generate a text message, a picture, an image, a sound, a light signal, a vibration caution, a color change and the like according to the collision prediction signal, such that corresponding changes are made on the wearable device 150. In such a manner, a user can quickly sense a collision about to happen or learn the information and the relative positions of adjacent ships faster. Compared with conventional identification of scenarios outside the cabin only with naked eyes, occurrence of erroneous judgment can be reduced greatly since human eye sights can be affected by factors such as weather and sunlight angle. In addition, the first computing device 130 can mark the first ship PO based on downloaded or real-time updated navigation information without manually selecting a monitoring object. For example, a server side may store pre-classified sea area classification information such as a covering range of a harbor area, a coast and an open sea. The above operation can be performed when network communications is available while the ship is near the coast, so as to store the required information for the use during navigation.

The communications device 110 can be achieved using the GPS. The sensing device 120 can be achieved by an automatic identification system (AIS), the first computing device 130 can be achieved as a micro computing processing box, the wearable device 150 can be achieved as a pair of AR eyeglasses, and the second computing device 140 can be devices such as a mobile phone, a tablet computer, a laptop computer and a desk computer to generate character, picture, image and sound data and transmit the character, picture, image and sound data to the wearable device 150. It is to be noted that the second computing device 140 and the wearable device 150 are in wired connection or wireless connection. In addition, the second computing device 140 can also be integrated into the wearable device 150. For example, the second computing device serves as a built-in processor or chip. The second computing device 140 is communicably connected with the first computing device 130 and is configured to receive the collision prediction signal transmitted by the first computing device 130. The second computing device 140 may include an image capture device such as a camera for retrieving images and identifying the images.

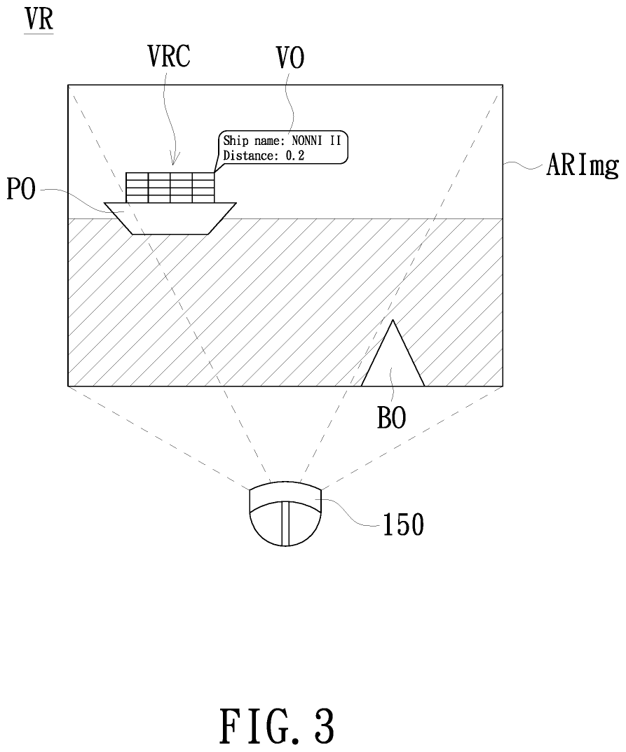

Referring to FIG. 3, FIG. 3 is a schematic diagram of a wearable device 150 of the ship navigation display system 100 displaying an augmented reality image. When the second computing device 140 communicably connected with the first computing unit 130 and configured to receive the collision prediction signal can project the second coordinate information corresponding to the first ship PO to a virtual coordinate VRC in a virtual space. The wearable device 150 is configured to receive the virtual coordinate VRC corresponding to the first ship PO and to display an augmented reality image ARImage accordingly, wherein a content of the augmented reality image ARImg includes a first virtual object VO corresponding to the virtual coordinate VRC and the first ship PO located in the physical environment PE (shown in FIG. 2).

In FIG. 3, the first virtual object VO is a text message, displaying contents such as “ship name: NONNI II and “distance: 0.2” (in other embodiments, nationality, navigation direction, navigation velocity and the like of the first ship PO can be displayed simultaneously), and the first virtual object VO can also achieve a caution effect by way of color change or flicker. In this way, the user of the wearable device 150 can clearly master related information about the first ship PO and know the distance between the first ship PO and the ship BO where the user is located in real time. For example, the first ship is 0.2 nautical mile away from the ship at present. According to an embodiment of the present invention, the size of the first virtual object VO in the augmented reality image ARImage can be adjusted according to the collision probability and the ship distance. For example, the first virtual object VO corresponding to a higher collision probability can be displayed in a larger size.

According to an embodiment of the present invention, the first computing device 130 can calculate a screening grade interval according to the first coordinate information and the sea area classification information of the ship BO. The first computing device 130 can mark the first ship PO based on downloaded or real-time updated navigation information without manually selecting a monitoring object. For example, a server side can obtain classified sea area classification information such as a covering range of a harbor area, a coast and an open sea by way of pre-classification or periodical downloading from the server side. The longitude and latitude position of the current ship on the Earth is obtained in real time by means of the sensing device 120 (e.g., a GPS receiver) carried on the ship. The area where the ship navigates at present is judged according to the GPS position and the sea area classification information of the ship, so as to further decide the screening grade interval, with which the information of surrounding ships is screened. The screening grade interval is transmitted to the second computing device 140. The second computing device 140 is configured to adjust a visual field of the wearable device 150 according to the screening grade interval and to display a second ship (e.g., an augmented reality ship generated by a computer, not shown in the drawings) in the visual field, wherein the visual field corresponds to the augmented reality image ARImage. For example, the screening grade interval can be calculated by means of a longitude and latitude algorithm to enhance the computing efficiency needed to access a ship list in an appointed circumference of the ship at present and detailed information thereof from a temporary storage database of the first computing device 130, so that the information can be quickly updated and acquired. The longitude and latitude algorithm is, for example the GeoHash algorithm that is an address encoding method, which can encode two-dimensional spatial longitude and latitude data into a character string and convert two-dimensional information into one-dimensional information so as to partition an address position. In other words, the area where the ship navigates at present is judged according to the GPS position and the sea area classification information of the ship, so as to further decide the screening grade interval, with which the information of surrounding ships is screened. The ship information to be examined is accessed according to an appointed condition, such that the number of times to continuously adjust the display rate in instrument operation can be decreased. The screening grade interval is obtained first via the above steps, and then the ship list in the appointed circumference of the ship at present and detailed information thereof from the temporary storage database are accessed according to the GeoHash algorithm, so that the computing efficiency can be improved greatly, and the information can be quickly updated and acquired.

Besides the above way to decide the screening grade interval, according to the present invention, a gesture image can be retrieved by the wearable device 150, and the gesture image is transmitted to the second computing device 140. Then, the second computing device 140 identifies the gesture image and transmits a command signal mapped by the gesture image to the first computing device 130. The first computing device 130 is configured to adjust the screening grade interval according to the command signal and transmits the command signal back to the second computing device 140, so that the second computing device 140 adjusts the visual field of the wearable device 150 according to the current screening grade interval and displays the second ship in the visual field.

According to an embodiment of the present invention, the second computing device 140 is configured to receive an angular velocity and an angular acceleration sensed by the wearable device 150 and to adjust a visual field of the wearable device 150 according to the angular velocity and the angular acceleration and to display a second ship in the visual field, wherein the visual field corresponds to the augmented reality image. For example, when the second computing device 140 is a mobile phone and the wearable device 150 is a pair of AR eyeglasses, and the user wears the wearable device 150 to examine surrounding conditions of the ship towards different directions, the mobile phone can read data, for example, gyroscope data, of an inertial measurement unit (IMU) in the AR eyeglasses. The orientation where the user examines is updated, and the visual field of the wearable device 150 is adjusted.

The virtual coordinate in the virtual space VR is virtual three-dimensional coordinate information, and the second computing device 140 is configured to convert the second coordinate information into the virtual three-dimensional coordinate information and further can render a second virtual object corresponding to the virtual three-dimensional coordinate information to the augmented reality image ARImage, wherein the second virtual object corresponds to a third ship (e.g., the augmented reality ship generated by the computer, not shown in the drawings). The second virtual object may include name information and number information of the third ship, wherein the name information and number information are sensed by the sensing device 120 and are transmitted to the second computing device 140 by means of the first computing device 130.

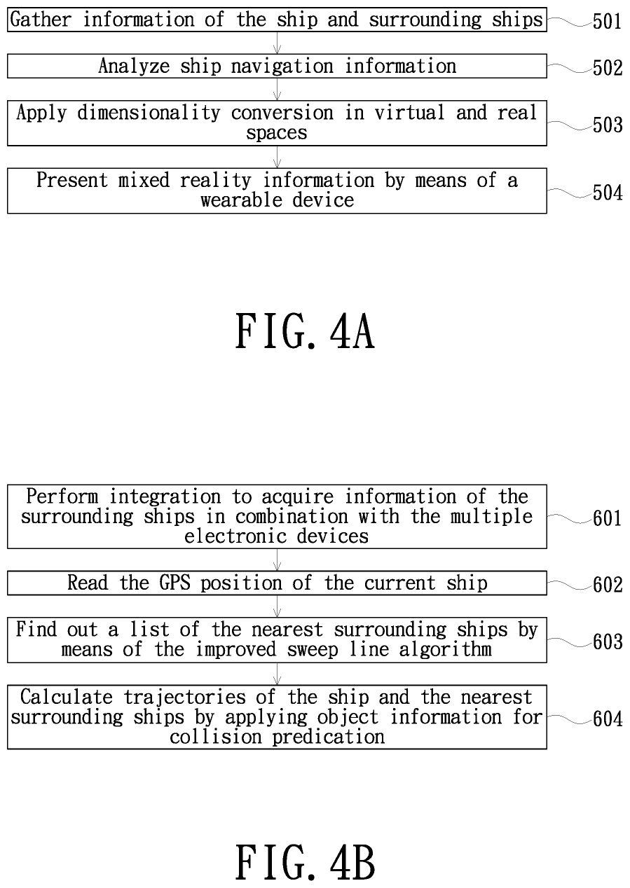

Referring to FIG. 1 and FIG. 4A, FIG. 4A is a flowchart of a ship navigation display method for collision prediction according to an embodiment of the present invention. The method shown in FIG. 4A can be adopted by the ship navigation display system 100 shown in FIG. 1. As shown in FIG. 4A, the method includes: S501, information of the ship and surrounding ships is gathered; S502: ship navigation information is analyzed; S503: dimensionality conversion in virtual and real spaces is applied; and S504: mixed reality information is presented by means of the wearable device.

In S501, related information (e.g., the distance to an obstacle) of surrounding objects of the ship can be acquired by means of the communications device 110 (such as radar), the ship navigation information can be acquired by means of the communications device 110 (e.g., an automatic identification system (AIS) and radar in combination with dedicated communications protocols J1939, NMEA 0183 and ITU-R M.1371 for ships) on the ship, and the longitude and latitude information of the ship on the Earth can be acquired by means of the GPS on the ship.

In S502, other ship information can be acquired by analyzing ITU-R M.1371-5 protocol data so as to identify surrounding ships. The first computing device 130 can automatically sense the distances between the ship and other ships in combination with data of multiple electronic devices on the ship by using an algorithm based on the improved sweep line algorithm, so as to provide ship collision prediction. The first computing device can automatically switch the screening grade interval according to the navigation position of the ship and access the ship information to be examined according to the appointed condition by means of the GeoHash algorithm, so as to screen the ship information.

In S503, spatial positioning can be achieved by means of dynamic spatial positioning by utilizing the second computing device 140 (e.g., the mobile phone) as a computing device. After the relative distance therebetween is calculated by applying an algorithm based on Haversine, the longitude and latitude position of the ship is converted from the coordinate in a two-dimensional space into a position coordinate in a three-dimensional real world by applying a coordinate conversion formula and a mixed reality algorithm, and meanwhile, the first virtual object VO corresponding to the virtual coordinate VRC is superposed to a picture of the physical environment PE (true space) to complete the augmented reality image ARImage where the virtual and real spatial objects are superposed, so as to display the augmented reality image ARImage on the wearable device 150 (e.g., the AR eyeglasses). In addition, the second computing device 140 may include an image capture device (not shown in the drawings, for example, the camera). A hand image can be inputted from the camera, and finger action is judged by means of an articulation point sensing technique in the hand image in the second computing device to complete gesture identification, so that the user interacts with the first virtual object VO or the augmented reality image ARImage.

In the S504, the micro computing processing box (e.g., the first computing device 130) gathers data of the multiple electronic devices on the ship for processing and analyzing so as to acquire complete information of the surrounding ships and collision prediction between the ship and the surrounding ships. In addition, a head-mounted display (e.g., the wearable device 150) can be worn and synchronously receives the complete information of the surrounding ships and collision prediction between the ship and the surrounding ships. The presented ship information (e.g., the first virtual object VO in FIG. 3) can be marked with volume labels of different sizes according to the distance levels, and event levels are marked with different colors. Furthermore, a display order of ships displayed in different sea area range can be adjusted by means of gesture identification, so that the ship information is presented more orderly. Referring to FIG. 4B, FIG. 4B is a flowchart of a micro computing processing box for collision prediction according to an embodiment of the present invention. The method shown in FIG. 4B can be adopted by the first computing device 130 shown in FIG. 1. As shown in FIG. 4B, the method includes: S601: integration is performed to acquire information of the surrounding ships in combination with the multiple electronic devices; S602: the GPS position of the current ship is read; S603: a list of the nearest surrounding ships is found by means of the improved sweep line algorithm; and S604: moving tracks of the ship and the nearest surrounding ships are calculated by applying object information for collision predication.

With respect to S601, the micro computing processing box can be installed on the ship for gathering data of the multiple electronic devices on the ship and reading data respectively gathered by the multiple electronic devices (e.g., radar, a velocity and distance recording apparatus, a rotary speed indicating meter, a long distance tracking and identification system, an AIS receiver and the like) carried on the ship and obtaining the complete information of the surrounding ships after being integrated.

With respect to S602, the longitude and latitude position of the current ship on earth is obtained in real time by means of the sensing device example a GPS receiver carried on the ship.

With respect to S603, the list of the nearest ships can be found by means of the Haversine algorithm assisted with the improved sweep line algorithm, and an ordering state is kept by applying a Binary Tree data structure. Compared with distance comparison by means of a method of exhaustion in the prior art, the method of the present invention can acquire the current surrounding ship list more efficiently.

With respect to S604, the nearest distance (CPA) and the nearest distance point time (TCPA) between the ship and each ship in the surrounding ship list by applying the navigation information such as longitude and latitude, true heading, true navigational speed and rotary rate assisted with marine weather, and collision prediction is performed by means of the two calculation results.

In view of the above, the present invention relates to a ship navigation assistant system applying a mixed reality. The ship navigation assistant system applying the mixed reality gathers ship-related information from multiple electronic devices by means of the dedicated communications protocol for ships, then performs collision prediction analysis by integrating the above-mentioned ship information and downloaded sea area classification information by means of the computing devices to generate collision caution information, and imports the above-mentioned ship information and the collision caution information into an augmented reality device (or a mixed reality device), so that the wearable device presents the ship navigation information and provides man-machine interaction.

What is claimed is:

1. A ship navigation display system set in a ship in a physical environment, comprising:
a communications device, configured to receive first coordinate information corresponding to the ship;
a sensing device communicably connected with the communications device, and configured to sense second coordinate information corresponding to a first ship around the ship;
a first computing device communicably connected with the communications device, and configured to calculate a collision probability according to the first coordinate information and the second coordinate information, wherein when the collision probability is greater than a threshold value, the first computing device transmits a collision prediction signal;
a second computing device communicably connected with the first computing unit, and configured to receive the collision prediction signal and to project the second coordinate information corresponding to the first ship to a virtual coordinate in a virtual space; and
a wearable device communicably connected with the second computing unit, and configured to receive the virtual coordinate and to display an augmented reality image, wherein a content of the augmented reality image comprises a first virtual object corresponding to the virtual coordinate and the first ship located in the physical environment.

2. The ship navigation display system according to claim 1, wherein the sensing device is further configured to sense a ship size, a ship distance, a navigation direction and a velocity corresponding to the first ship; and the first computing device is configured to calculate the collision probability according to the first coordinate information, the second coordinate information, the ship size, the ship distance, the navigation direction and the velocity.

3. The ship navigation display system according to claim 2, wherein the size of the first virtual object in the augmented reality image is adjusted according to the collision probability and the ship distance.

4. The ship navigation display system according to claim 1, wherein the first computing device calculates a screening grade interval according to the first coordinate information and sea area classification information, and transmits the screening grade interval to the second computing device; and the second computing device is configured to adjust a visual field of the wearable device according to the screening grade interval and to display a second ship in the visual field, wherein the visual field corresponds to the augmented reality image.

5. The ship navigation display system according to claim 1, wherein the second computing device is configured to receive an angular velocity and an angular acceleration sensed by the wearable device, and to adjust a visual field of the wearable device according to the angular velocity and the angular acceleration and to display a second ship in the visual field, wherein the visual field corresponds to the augmented reality image.

6. The ship navigation display system according to claim 1, wherein the virtual coordinate in the virtual space is virtual three-dimensional coordinate information, and the second computing device is configured to convert the second coordinate information into the virtual three-dimensional coordinate information and is further configured to render a second virtual object corresponding to the virtual three-dimensional coordinate information to the augmented reality image, wherein the second virtual object corresponds to a third ship.

7. The ship navigation display system according to claim 6, wherein the second virtual object comprises name information and number information, and the name information and the number information is sensed by the sensing device and transmitted to the second computing device by means of the first computing device.

8. The ship navigation display system according to claim 1, wherein the wearable device is configured to retrieve a gesture image and to transmit the gesture image to the second computing device; the second computing device is configured to identify the gesture image and to transmit a command signal mapped by the gesture image to the first computing device; the first computing device is configured to adjust a screening grade interval according to the command signal and to transmit the command signal back to the second computing device; and the second computing device is configured to adjust a visual field of the wearable device according to the screening grade interval and to display a second ship in the visual field, wherein the visual field corresponds to the augmented reality image.

9. A ship navigation display method applied to a ship navigation display system in a ship in a physical environment, the ship navigation display system comprising a communications device, a sensing device, a first computing device, a second computing device and a wearable device, wherein the sensing device is communicably connected with the communications device, the first computing device is communicably connected with the communications device, the second computing device is communicably connected with the first computing device, and the wearable device is communicably connected with the second computing device; the ship navigation display method comprising:
receiving, by the communications device, first coordinate information corresponding to the ship;
sensing, by the sensing device, second coordinate information corresponding to a first ship around the ship;
calculating, by the first computing device, a collision probability according to the first coordinate information and the second coordinate information, wherein when the collision probability is greater than a threshold value, and the first computing device transmits a collision prediction signal;
receiving, by the second computing device, the collision prediction signal and projecting, by the second computing device, the second coordinate information corresponding to the first ship to a virtual coordinate in a virtual space; and
receiving, by the wearable device, the virtual coordinate and displaying, by the wearable device, an augmented reality image, wherein a content of the augmented reality image comprises a first virtual object corresponding to the virtual coordinate and the first ship located in the physical environment.

10. The ship navigation display method according to claim 9, further comprising:
sensing, by the sensing device, a ship size, a ship distance, a navigation direction and a velocity corresponding to the first ship; and
calculating, by the first computing device, the collision probability according to the first coordinate information, the second coordinate information, the ship size, the ship distance, the navigation direction and the velocity.

11. The ship navigation display method according to claim 10, wherein the size of the first virtual object in the augmented reality image is adjusted according to the collision probability and the ship distance.

12. The ship navigation display method according to claim 9, further comprising:
calculating, by the first computing device, a screening grade interval according to the first coordinate information and sea area classification information, and transmitting, by the first computing device, the screening grade interval to the second computing device; and
adjusting, by the second computing device, a visual field of the wearable device according to the screening grade interval and displaying, by the second computing device, a second ship in the visual field, wherein the visual field corresponds to the augmented reality image.

13. The ship navigation display method according to claim 9, further comprising:
receiving, by the second computing device, an angular velocity and an angular acceleration sensed by the wearable device and adjusting, by the second computing device, a visual field of the wearable device according to the angular velocity and the angular acceleration and displaying, by the second computing device, a second ship in the visual field, wherein the visual field corresponds to the augmented reality image.

14. The ship navigation display method according to claim 9, wherein the virtual coordinate in the virtual space is virtual three-dimensional coordinate information, and the second computing device is configured to convert the second coordinate information into the virtual three-dimensional coordinate information and is further configured to render a second virtual object corresponding to the virtual three-dimensional coordinate information to the augmented reality image, wherein the second virtual object corresponds to a third ship.

15. The ship navigation display method according to claim 14, wherein the second virtual object comprises name information and number information, and the name information and the number information being sensed by the sensing device and transmitted to the second computing device by means of the first computing device.

16. The ship navigation display method according to claim 9, comprising:
retrieving, by the wearable device, a gesture image and transmitting, by the wearable device, the gesture image to the second computing device;
identifying, by the second computing device, the gesture image and transmitting, by the second computing device, a command signal mapped by the gesture image to the first computing device;
adjusting, by the first computing device, a screening grade interval according to the command signal and transmitting, by the first computing device, the command signal back to the second computing device; and
adjusting, by the second computing device, a visual field of the wearable device according to the screening grade interval and displaying, by the second computing device, a second ship in the visual field, wherein the visual field corresponds to the augmented reality image.

17. A ship navigation display method applied to a first computing device, wherein the first computing device is communicably connected with a second computing device, a communications device and a sensing device respectively, and the second computing device is communicably connected with a wearable device; the ship navigation display method comprising:
receiving first coordinate information corresponding to a ship from the communications device;
receiving second coordinate information corresponding to a first ship from the sensing device; and
calculating a collision probability according to the first coordinate information and the second coordinate information, wherein when the collision probability is greater than a threshold value, a collision prediction signal is transmitted;
wherein when the second computing device receives the collision prediction signal, the second computing device projects the second coordinate information corresponding to the first ship to a virtual coordinate in a virtual space and transmits the virtual coordinate to the wearable device to display an augmented reality image, a content of the augmented reality image comprising a first virtual object corresponding to the virtual coordinate and the first ship located in the physical environment.

18. The ship navigation display method according to claim 17, wherein the sensing device senses a ship size, a ship distance, a navigation direction and a velocity corresponding to the first ship, and the size of the first virtual object in the augmented reality image is adjusted according to the collision probability and the ship distance, the ship navigation display method further comprising:
calculating the collision probability according to the first coordinate information, the second coordinate information, the ship size, the ship distance, the navigation direction and the velocity.

19. The ship navigation display method according to claim 17, further comprising:
calculating a screening grade interval according to the first coordinate information and sea area classification information, and transmitting the screening grade interval to the second computing device, wherein the second computing device adjusts a visual field of the wearable device according to the screening grade interval and displays a second ship in the visual field, and the visual field corresponds to the augmented reality image.

20. A ship navigation display system, the ship navigation display system being communicably connected with a wearable device and being set in a ship in a physical environment, comprising:
a communications device, configured to receive first coordinate information corresponding to the ship;
a sensing device communicably connected with the communications device, configured to sense second coordinate information corresponding to a first ship around the ship;
a first computing device communicably connected with the communications device, configured to calculate a collision probability according to the first coordinate information and the second coordinate information, wherein when the collision probability is greater than a threshold value, the first computing device transmits a collision prediction signal; and
a second computing device communicably connected with the first computing device, configured to receive the collision prediction signal, to project the second coordinate information corresponding to the first ship to a virtual coordinate in a virtual space and to transmit an augmented reality image to the wearable device to display, a content of the augmented reality image comprising a first virtual object corresponding to the virtual coordinate and the first ship located in the physical environment.
